(19) United States
(12) Patent Application Publication
(10) Pub. No.: US 2009/0057215 A1
(43) Pub. Date: Mar. 5, 2009

(54) LOW CONCENTRATION SEWAGE TREATMENT SYSTEM COMBINED WITH LANDSCAPE

(75) Inventor: Qingmei Li, Beijing (CN)

Correspondence Address: YING CHEN;Chen Yoshimura LLP, 255 S. GRAND AVE., # 215, LOS ANGELES, CA, 90012, US

(73) Assignee: BEIJING NENGTUO HIGH TECHNOLOGY CO., LTD, Beijing (CN)

(21) Appl. No.: 12/110,437

(22) Filed: Apr. 28, 2008

(30) Foreign Application Priority Data
Aug. 27, 2007 (CN) 200710120781.8

(51) Int. Cl. C02F 3/32

(52) U.S. Cl. 210/170.08; 210/602

(57) ABSTRACT

This invention concerns a low concentration sewage treatment system combined with landscape, comprising a primary filter unit, a rotation flow separator combination and a primary aerobic aeration tank, wherein the back of said primary aerobic aeration tank is connected with a wetland bio-landscape facility of residential plot, the said wetland bio-landscape is equipped with aeration plants. This system adopts wetland, a kind of bio-landscape in a residential district, as a meaning of sewage purification to reduce capital investment and land occupation and to beautify the environment.

### BACKGROUND OF THE INVENTION

1. Field of the Invention

This invention relates to a low concentration sewage treatment system combined with landscape and belongs to the filed of environmental protection technique.

2. Description of the Related Art

As the appliance of separate collection of sewage source approaches, the sewage is divided into two categories. One is the high concentration sewage discharged from toilets of which the main pollutants are squat ware and urinal. This kind of sewage needs to be specially treated. The other is normal sewage of low pollution concentration and can meet reuse standards by a simpler treatment. A current small sewage treatment systems aims to treat mix collection of sewage. The pollution concentration of mix collection of sewage is between high concentration sewage and low concentration sewage. Such a system is not suitable for low concentration sewage treatment for its high cost. In addition, such a system is mainly a larger civil construction and needs a large area of land and huge capital investment. So, a suitable treatment system is needed to treat the low concentration sewage.

### SUMMARY OF THE INVENTION

To overcome the present technical deficiencies, this invention offers a low concentration sewage treatment system combined with landscape. This system adopts wetland, a kind of bio-landscape in a residential district, as a meaning of sewage purification to reduce capital investment and land occupation and to beautify the environment.

The technical solution of the present invention to achieve above purposes is: a low concentration sewage treatment system combined with landscape, mainly comprising a primary filter unit, a rotation flow separator combination and a primary aerobic aeration tank, wherein the back of said primary aerobic aeration tank is connected with a wetland bio-landscape facility of residential plot, the said wetland bio-landscape is equipped with aeration plants.

Because of the reasonable integral treatment process designed in this invention, most of the particulates are removed by the primary filtering and sloping board settling so that the main part of pollution in sewage are removed. Then, through the aerobic aeration, not only part of residual BOD and COD in sewage is removed, but also oxygen content in sewage is effectively increased. The sewage in the wetland bio-landscape facility is treated further by an aerobic biochemical treatment method to improve the treatment performance and reach a good purifying efficiency. The water discharged from this system can be reused in the maintenance of landscape and etc.

### BRIEF DESCRIPTION OF THE DRAWINGS

FIG. 1 is a structural scheme of said system.

### DETAILED DESCRIPTION OF THE PREFERRED EMBODIMENTS

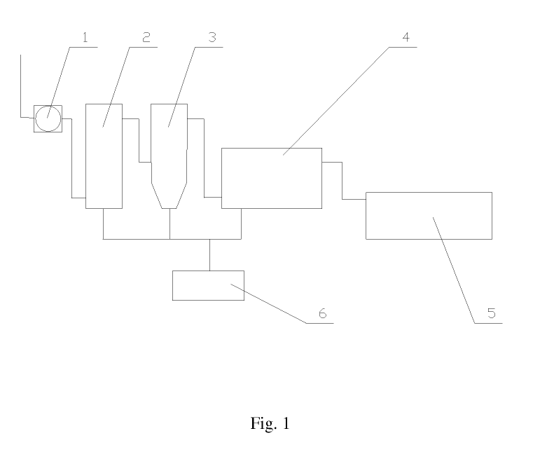

With reference to FIG. 1, this invention provides a low concentration sewage treatment system combined with landscape, mainly comprising a primary filter unit 2, a rotation flow separator combination 3 and a primary aerobic aeration tank 4, wherein the back of said primary aerobic aeration tank is connected with a wetland bio-landscape facility 5 of residential plot, the said wetland bio-landscape is equipped with aeration plants.

The said primary filter unit consists of several filtration modules which filter the large volume solids in sewage. The filtration modules utilize standardization design by which they can realize the optimal separation performance. The filtration modules can be connected with each other by a paralleled method to ensure the filtering performance and keep the required resistance when the sewage amount changes. The said filtration modules can have a filter gauze structure and the said gauze can be fixed on the gauze frameworks. Several said frameworks can be installed on the primary filter unit by a paralleled method to form effective filtering surface.

The said rotation flow separator combination consists of several rotation flow separators installed by a paralleled method. Proper amount of rotation flow separators can be set and initiated according to the water volume to ensure the rotation flow separator operating in an optimal working condition.

There are several aerators at the bottom of the said aerobic aeration tank. There are several aerobic bio-filter membrane modules in the aerobic aeration tank and the tank is divided into several water channels.

In view of the main pollutants of low concentration sewage are BOD and COD, the advanced treatment aerobic biochemical approach with better treatment performance, which is suitable for low concentration sewage, is used to ensure the purification degree of outlet water and make it meet the intermediate water reuse standards.

A sterilization device can be installed at the back of primary aerobic aeration tank. The said sterilization device consists of several sterilization modules with options of ozone sterilization module, electrolysis metallic iron sterilization module and chemical sterilization module. The modularization of sterilization device can realize the standardization design of sterilization module and ensure proper amount of sterilization modules can be installed on the sterilization device.

A crushing device 1 can be installed in front of the said primary filter unit to crush the raffles carried in the sewage so as to make it meet the subsequent treatment requirement.

The said primary filter unit, rotation flow separator combination, primary aerobic aeration tank and sterilization device are designed with sludge discharge outlet. The said sludge discharge outlet is connected to the sludge tank 6 via sludge pipe for centralized treatment.

All the said parts are connected by sewage pipes and equipped with relevant pumps for supplying power for sewage and sludge flowing.

The advantages of this system are as follows:

(1) It complies with the collection and treatment concepts of sewage sources separation and aims at the low concentration sewage treatment which can not be effectively solved under current technical conditions. It treats and reuses the sewage in situ and significantly reduces the land occupation of sewage treatment pipelines, and solves the sewage treatment problem of small scale sewage sources. This approach is mutually complemented with traditional civil construction-featured centralized treatment systems, utilizes the device-featured distributive and compact treatment system according to the site conditions and treats the distributive pollution sources on site without need of more capital investment to set up centralized water treatment plant so that it reduces a large amount of costs and land resources and enable to timely treat the newly emerging pollutant sources.

(2) Due to its flexible and effective setting with strong pertinence and updatability and saving of investment and land occupation, it can carry out stage treatment of sewage in local location for the water regeneration, stage or cycling operation and multi-appliances to increase the water utilization rate and reduce the pollution discharge.

(3) It realizes the water cycling utilization and significant reduces the supplemental water volume and sewage discharge volume. Its lower equipment expense saves large amount of expense compared with other treatment program so that it is easily accepted by pollution generation units for their economical and effective treatment of self-generated pollutants.

What is claimed is:

1. A low concentration sewage treatment system combined with landscape, comprising: a primary filter unit, a rotation flow separator combination and a primary aerobic aeration tank, wherein a back of said primary aerobic aeration tank is adapted to be connected with a wetland bio-landscape facility of residential plot, the wetland bio-landscape being equipped with aeration plants.

2. The system of claim 1, wherein the primary filter unit includes several filtration modules, the filtration modules have a filter gauze structure, the gauzes being fixed on filter gauze frameworks.

3. The system of claim 2, wherein the frameworks are installed on the primary filter unit by a paralleled method.

4. The system of claim 3, wherein the rotation flow separator combination includes several parallel rotation flow separators.

5. The system of claim 4, further comprising aerators at a bottom of the aerobic aeration tank.

6. The system of claim 5, further comprising aerobic bio-filter membrane modules in the aerobic aeration tank, wherein the aerobic aeration tank is divided into several water channels.

7. The system of claim 1, further comprising a sterilization device installed at the back of said primary aerobic aeration tank.

8. The system of claim 7, wherein the sterilization device includes sterilization modules.

9. The system of claim 8, wherein the sterilization modules are ozone sterilization modules, electrolysis metallic iron sterilization modules or chemical sterilization modules.

10. The system of claim 9, further comprising a crushing device installed on a front of the said primary filter unit.

11. The system of claim 10, wherein the primary filter unit, the rotation flow separator combination, the primary aerobic aeration tank and the sterilization device are equipped with sludge discharge outlets, wherein each of the sludge discharge outlets is connected to a sludge tank via a sludge pipe.

12. The system of claim 3, further comprising a sterilization device installed at the back of said primary aerobic aeration tank.

13. The system of claim 12, wherein the sterilization device includes sterilization modules.

14. The system of claim 13, wherein the sterilization modules are ozone sterilization modules, electrolysis metallic iron sterilization modules or chemical sterilization modules.

15. The system of claim 14, further comprising a crushing device installed on a front of the said primary filter unit.

16. The system of claim 15, wherein the primary filter unit, the rotation flow separator combination, the primary aerobic aeration tank and the sterilization device are equipped with sludge discharge outlets, wherein each of the sludge discharge outlets is connected to a sludge tank via a sludge pipe.

17. The system of claim 5, further comprising a sterilization device installed at the back of said primary aerobic aeration tank.

18. The system of claim 17, wherein the sterilization device includes sterilization modules, and wherein the sterilization modules are ozone sterilization modules, electrolysis metallic iron sterilization modules or chemical sterilization modules.

19. The system of claim 18, further comprising a crushing device installed on a front of the said primary filter unit.

20. The system of claim 19, wherein the primary filter unit, the rotation flow separator combination, the primary aerobic aeration tank and the sterilization device are equipped with sludge discharge outlets, wherein each of the sludge discharge outlets is connected to a sludge tank via a sludge pipe.
